(19) United States
(12) Patent Application Publication
(10) Pub. No.: US 2004/0207699 A1
(43) Pub. Date: Oct. 21, 2004

(54) Ink-jet cartridges

(76) Inventor: Clive Drake, Surrey (GB)

Correspondence Address: Melvin I. Stoltz, Esq., 51 Cherry Street, Milford, CT, 06460, US

(21) Appl. No.: 10/839,594

(22) Filed: May 5, 2004

(30) Foreign Application Priority Data
Jun. 21, 2002 (GB) 0214370.9
Feb. 26, 2003 (GB) 0304346.0
Sep. 17, 2003 (GB) 0321821.1

(51) Int. Cl. B41J 2/175

(52) U.S. Cl. 347/86

(57) ABSTRACT

An ink-jet cartridge includes a chamber (10) for ink and means for controlling the flow of ink from the chamber in the form of a coil (“a”) of thin stainless steel sheet material arranged so that the ink flows from the chamber along a spiral path defined by the coil (“a”).

### FIELD OF THE INVENTION

This invention relates to ink-jet cartridges, i.e. to ink cartridges for use in ink-jet printers.

### BACKGROUND TO THE INVENTION

An ink-jet printer includes a very precise micro-pump, i.e. there is a mechanism which, on the inlet side, produces a suction force which is then converted into the ejection of a liquid ink drop onto the medium beneath it.

If ink simply flooded out of the ink cartridge with no flood regulation, then the print head would simply be a valve which opened and closed to permit ink to flow, but this would not enable the precise formation of an ink drop, which is what is required for digital printing.

The ink-jet cartridges at present in use thus typically include a sponge the purpose of which is only to release the ink when the print head is actually creating a demand for it. This demand manifests itself as a suction force that is generated by the print head. If the ink is released too easily, the print head will flood and produce drops of varying sizes. If the ink is released too slowly, then ink starvation results. The print that is formed can thus have many drops missing, which are recognised as white lines. The optimum suction range is between about 4 and 50 mbar, depending on the properties of the printing liquid.

In currently available sponge-based ink-jet cartridges, the sponge is compressed thereby producing a capillary force that regulates the flow of ink, i.e. the ink is released only when the print head suction is sufficiently great to overcome the capillary force of the sponge.

This arrangement has a number of disadvantages, as follows:

a) as the cartridge is emptied during use, the ink has to travel further through the sponge, requiring an increased force to pull the ink into the print head, thus producing diminishing print quality during the final part of the life of the cartridge,

b) as the cartridge and the sponge will inevitably retain some of the impregnated ink, the actual yield of the cartridge falls a long way below the theoretical maximum, thus wasting ink,

c) as the cartridge reaches the end of its print life, the print head will have to work harder to suck ink from the furthest extremities of the sponge, thus shortening the life of the print head, and

d) the only inks which can be used are those which are not affected by the sponge and do not themselves affect the sponge.

It is an object of the present invention to provide an improved form of ink-jet cartridge.

It is a more specific object of the present invention to provide an ink-jet cartridge the design of which is such as to avoid the disadvantages of the sponge-based cartridges, as outlined above.

### SUMMARY OF THE INVENTION

According to the present invention there is provided an ink-jet cartridge that includes a chamber for ink and means for controlling the flow of ink from the chamber in the form of a coil of sheet material so arranged that the ink flows from the chamber along a spiral path between adjacent turns of the coil.

The coil of sheet material is preferably of stainless steel sheet which is rolled into a coil in such manner that the tension in the coil ensures a substantially constant gap between adjacent turns of the coil.

The stainless steel sheet preferably has a length of about 30 mm. and is preferably so wound that the coil extends through at least two revolutions, and preferably less than three revolutions. The coil preferably extends through two and a quarter revolutions.

The coil is preferably located in a trough formed in the bottom of the cartridge so that it is constantly immersed in ink.

The ends of the coil are preferably sealed and the arrangement is preferably such that the outside of the coil communicates with the ink-containing chamber of the cartridge, while the centre of the coil communicates with the discharge outlet of the cartridge.

Communication between the centre of the coil and the discharge outlet is preferably via a feed column which provides a head of about 20 mm. to ensure a constant even feed of ink to the printer.

The arrangement will thus be such that the viscosity of the ink and the surface drag within the gap between adjacent turns of the coil provides the required resistance to maintain a constant head pressure within the cartridge.

Secondary means may be provided for controlling the flow of ink from the chamber. Such secondary means may be in the form of a valve having a closure member that is movable between a position in which flow of ink from the chamber is permitted and a position in which the flow of ink from the chamber is prevented.

The valve closure member is preferably of spherical configuration and acted on by a spring that urges the spherical valve closure member into engagement with a downwardly facing generally conical valve seat. The spring is preferably of conical form and is so arranged that it will only deflect when sufficient suction is applied to the underside of the spherical valve closure member to permit the flow of ink.

### BRIEF DESCRIPTION OF THE DRAWINGS

FIG. 1 is a sectional view of the base of a first embodiment of ink-jet cartridge,

FIG. 2 is a sectional view of the ink-jet cartridge of FIG. 1 at right angles to the section of FIG. 1,

FIG. 3 is a perspective view of a spiral coil that sits in the base of the ink-jet cartridge,

FIG. 4 is a sectional view, similar to FIG. 1, of a second form of ink-jet cartridge,

FIG. 5 is a sectional view similar to FIG. 1, of a third form of ink-jet cartridge,

FIG. 6 is a sectional view of the cartridge of FIG. 5 along the line 5-5 of FIG. 5,

FIG. 7 is a sectional view of the base of a fourth form of ink-jet cartridge, and

FIG. 8 is a sectional view of the base of the ink-jet cartridge of FIG. 7, taken at right angles to FIG. 7.

### DESCRIPTION OF THE PREFERRED EMBODIMENTS

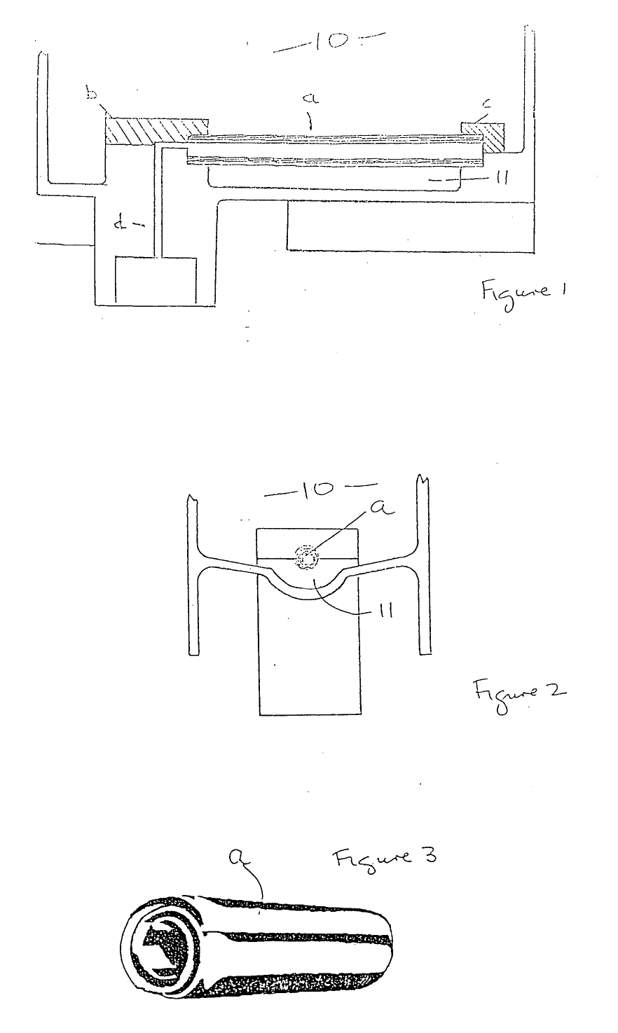

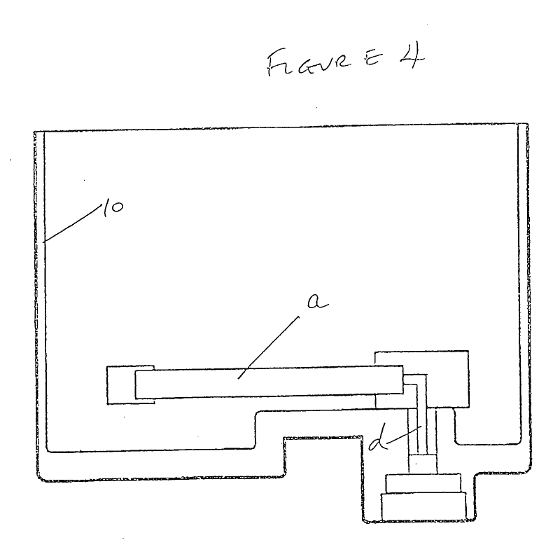

The ink-jet cartridge shown in FIGS. 1 to 3 of the drawings is intended to be used in a standard ink-jet printer having a print head mounted on a carriage that traverses a page to which ink is to be applied. The cartridge includes a chamber 10 within which the ink is contained and, at the base of the chamber 10, there is a trough 11 in which a stainless steel coil “a” is located. The stainless steel coil “a” comprises two and a quarter revolutions of micro-thin stainless steel sheet 30 mm. long wound into a spiral coil in such manner that the tension in the coil ensures that there is a small, substantially constant gap between adjacent turns of the coil “a”.

The interaction of the viscosity of the ink in the chamber 10 and the surface drag within the gap between adjacent turns of the coil “a” ensures that the required flow resistance is obtained to maintain the constant head pressure within the cartridge and the 2G (twice the force of gravity) impulse generated by the print head's carriage movement as it traverses the page during printing. The stainless steel coil “a” thus acts as a flow control coil.

The flow control coil “a” is mounted at its ends between seals “b” and “c” and the flow control coil “a” is employed to induce the ink flow to the print head by vacuum-assisted gravity flow. Positioning of the coil “a” in the trough 11 ensures that it is constantly immersed in ink and there is a 20 mm. head feed column “d” to ensure that there is a constant even feed of ink from the chamber 10 as and when the printer demands it.

The embodiment shown in FIG. 4 functions in the same way as the embodiment described above. It includes a stainless steel flow control coil “a”, as described above, which is contained in the base of the chamber 10 so that it is constantly immersed in the ink in the chamber 10. The coil “a” is sealed at its two ends and there is again a 20 mm. head feed column “d” to ensure that a constant even flow of ink from the chamber is maintained.

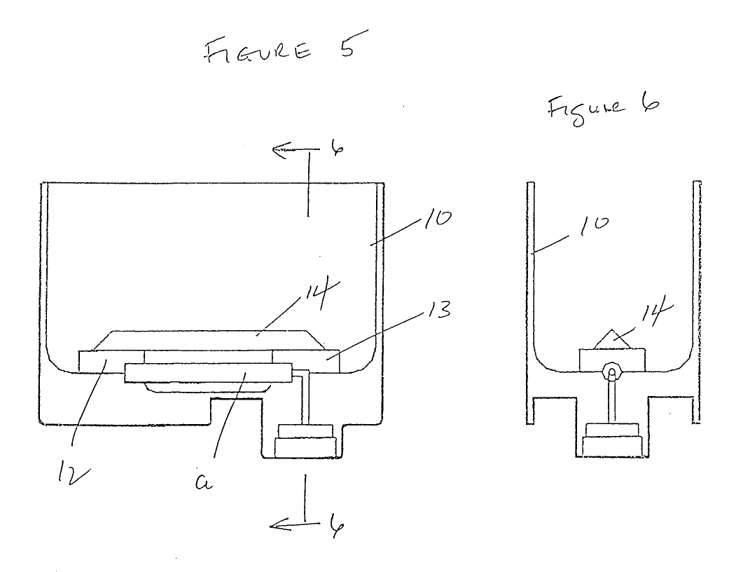

In the embodiment shown in FIGS. 5 and 6, there is again a stainless steel flow control coil “a”, that is as described above, and the flow control coil “a” is sealed at its two ends by being mounted in adaptors 12 and 13 that are connected by a bridge piece 14 that serves to hold the adaptors 12 and 13 securely in position in the base of the chamber 10 of the cartridge. There is again a 20 mm. head feed column “d” to ensure that a constant even flow of ink from the chamber is maintained.

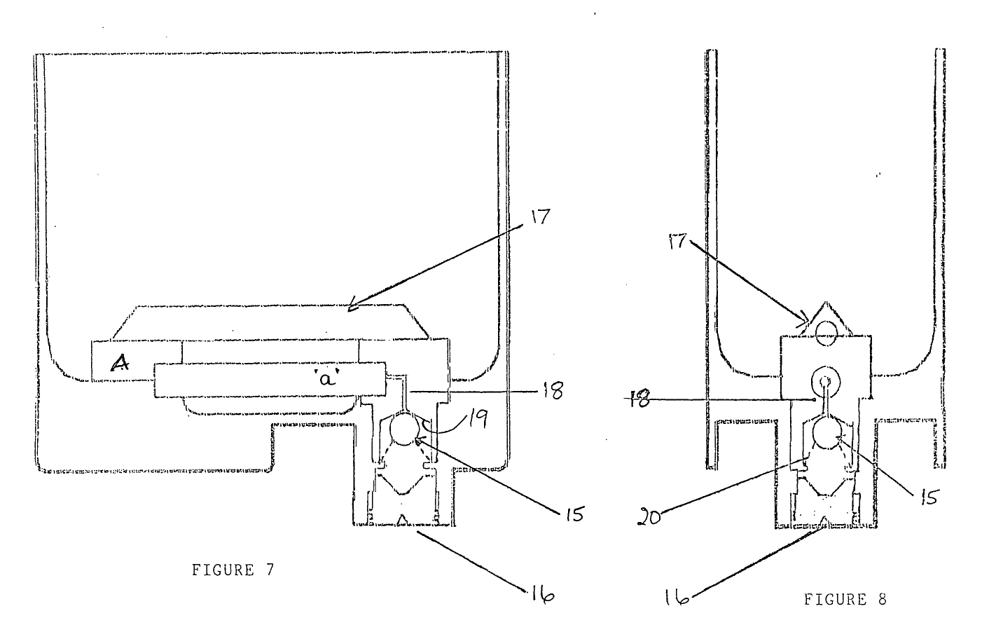

The ink-jet cartridge shown in FIGS. 7 and 8 is a modification of the ink-jet cartridge shown in FIGS. 1 to 3 and differs therefrom in that a closure valve 15 is interposed between the stainless steel spiral coil “a” and the cartridge outlet port 16. As shown in FIG. 7, the spiral coil “a” is held in place by a locating piece 17 that serves to form a liquid-tight seal at end A of the spiral coil “a” and fixes the spiral coil “a” in the cartridge. The locating piece 17 is so designed that the other end of the coil “a” is connected to the ink outlet port 16 via an ink channel 18.

The closure valve 15 comprises a ball bearing that is urged upwardly into engagement with a downwardly facing valve seat 19 by means of a conical spring 20. The ball bearing is normally in engagement with the valve seat 19 so as to prevent the flow of ink to the ink outlet port 16. When, however, a printing cycle of operations is initiated and suction is applied to the underside of the ball bearing, the spring 20 will be deflected sufficiently for the ball bearing to move downwardly out of engagement with the valve seat 19 to permit the flow of ink to the ink outlet port 16.

The flow of ink to the ink outlet port 16 is controlled essentially by the spiral coil “a”, but the closure valve 15 serves to ensure that there is no possibility of leakage of ink from the ink outlet port 16.

The provision of the stainless steel control coil “a” reduces or avoids the various disadvantages of the known ink-jet cartridges which contain sponges, as referred to in the introduction hereto.

1. An ink-jet cartridge that includes a chamber for ink and means for controlling the flow of ink from the chamber in the form of a coil of sheet material so arranged that the ink flows from the chamber along a spiral path between adjacent turns of the coil.

2. An ink-jet cartridge as claimed in claim 1, in which the coil of sheet material is of stainless steel sheet.

3. An ink-jet cartridge as claimed in claim 2, in which the stainless steel sheet is rolled into a coil in such manner that the tension in the coil ensures a substantially constant gap between adjacent turns of the coil.

4. An ink-jet cartridge as claimed in claim 2, in which the stainless steel sheet has a length of about 30 mm.

5. An ink-jet cartridge as claimed in claim 4, in which the stainless steel sheet is so wound that the coil extends through at least two revolutions and through less than three revolutions.

6. An ink-jet cartridge as claimed in claim 5, in which the coil extends through two and a quarter revolutions.

7. An ink-jet cartridge as claimed in claim 1, which includes a discharge outlet, and in which the coil is located in a trough formed in the bottom of the cartridge so that it is constantly immersed in ink, the ends of the coil being sealed and the arrangement being such that the outside of the coil communicates with the ink-containing chamber of the cartridge, while the centre of the coil communicates with the discharge outlet of the cartridge.

8. An ink-jet cartridge as claimed in claim 7, in which communication between the centre of the coil and the discharge outlet is via a feed column which provides a head of about 20 mm. to ensure a constant even feed of ink to the printer.

9. An ink-jet cartridge as claimed in claim 1, in which secondary means are provided for controlling the flow of ink from the chamber, such secondary means being in the form of a valve having a closure member that is movable between a position in which flow of ink from the chamber is permitted and a position in which the flow of ink from the chamber is prevented.

10. An ink-jet cartridge as claimed in claim 9, in which the valve closure member is of spherical configuration and is acted on by a spring that urges the spherical valve closure member into engagement with a downwardly facing generally conical valve seat.
